(19) United States
(12) Patent Application Publication
(10) Pub. No.: US 2011/0114114 A1
(43) Pub. Date: May 19, 2011

(54) CLEANING METHOD OF APPARATUS FOR DEPOSITING CARBON CONTAINING FILM

(75) Inventors: Dong-Ho You, Kyungki-do (KR); Jung-Work Lee, Seoul (KR)

(73) Assignee: IPS Ltd., Pyungtaek-si, Kyungki-do (KR)

(21) Appl. No.: 13/054,072

(22) PCT Filed: Jul. 14, 2008
(86) PCT No.: PCT/KR2008/004133

§ 371 Date: Jan. 13, 2011

(51) Int. Cl. B08B 7/00

(52) U.S. Cl. 134/1.1

(57) ABSTRACT

A dry cleaning method of an apparatus for depositing a carbon-containing film is provided. The method includes in-situ cleaning an inside of a reactor of the apparatus, wherein the cleaning of the inside of the reactor of the apparatus comprises supplying a cleaning gas including halogens with being activated by using a remote plasma generator to the reactor and simultaneously supplying a carbon-removing gas without being activated to the reactor. In the method, a by-product in a solid form is not generated, and in-situ cleaning can be performed without stopping the apparatus for depositing a carbon-containing film after a predetermined amount of wafers are treated, such that productivity of the apparatus for depositing a carbon-containing film can be maximized.

### TECHNICAL FIELD

The present invention relates to a cleaning method of an apparatus for manufacturing a semiconductor, and more particularly, to a dry cleaning method of a reactor of an apparatus for depositing a carbon-containing film.

### BACKGROUND ART

Generally, semiconductor devices are manufactured by using a plurality of unit processes such as an ion implantation process, a film formation process, a diffusion process, a photolithography process, and an etching process. The film formation process among the unit processes is an essential process that must be improved in reproducibility and reliability of semiconductor device manufacturing.

A film of a semiconductor device is formed on a wafer by using methods such as sputtering, evaporation, chemical vapor deposition (CVD), and atomic layer deposition (ALD) etc. Apparatuses for depositing a film used to perform the methods generally include a reactor, a gas line for supplying various kinds of gases to the reactor, and a wafer block on which the wafer is disposed.

However, while a film formation process is performed by using an apparatus for depositing a film, a reaction product that is generated during the film formation process is deposited on (attached to) the surface of a semiconductor film and the inner walls of the reactor. Apparatuses for depositing a film for semiconductor mass production treat a large amount of wafers. Thus, when a semiconductor manufacturing process is consecutively performed in the state where the reaction product is attached to the reactor, the characteristic of a film in a semiconductor manufacturing process may be changed. The most representative example thereof is a change in film resistance or thickness and particles that are finally generated due to the exfoliation of the reaction product. These particles cause defects in a deposition process and are attached to the wafer, which result in deterioration of the yield of a semiconductor device.

As such, in conventional semiconductor manufacturing methods, an apparatus for depositing a film is stopped after a wafer deposition process is performed fora predetermined amount of time or a predetermined number of wafers are deposited before a change in film occurs, and a reactor is exposed to the air so that the reactor and each of elements of the reactor are separated from one another. After foreign substances that are deposited on the reactor and each element are cleaned by using a volatile material such as alcohol, the separated reactor is re-combined. Generally, such a cleaning method is referred to as ex-situ cleaning. In the ex-situ cleaning method, productivity is remarkably reduced when a semiconductor is manufactured, and a change-point of equipment is generated.

Another cleaning method of an apparatus for depositing a film is a dry cleaning method, so-called in-situ cleaning, by which a deposition product inside a reactor is removed by using a corrosive gas without stopping the apparatus for depositing a film. For example, a perfluorized compound gas, such as CF₄, C₂F₆, C₃F₈, C₄F₈, CHF₃ or SF₆, or NF₃ as a cleaning gas for cleaning the apparatus for depositing a film such as silicon (Si), silicon oxide (SiOₓ) or silicon nitride (SiNₓ) is injected into the reactor, thereby removing the film.

In particular, as semiconductor devices are integrated, attempts for containing carbon in a film, such as deposition of a low dielectric constant (low-k) film such as SiOCH, have been made so as to reduce a leakage current. A metal nitride film such as TaN may contain carbon of 10-20%. In this way, in an apparatus for depositing a film in which 5% or more carbon is contained, when dry cleaning is performed by using a conventional corrosive gas, a white powder based on fluoride carbon (CF*) is generated as a by-product. As such, an improved dry cleaning method of an apparatus for depositing a carbon-containing film is required.

### DISCLOSURE

### Technical Problem

The present invention provides a dry cleaning method of an apparatus for depositing a carbon-containing film.

### Technical Solution

According to an aspect of the present invention, there is provided a dry cleaning method of an apparatus for depositing a carbon-containing film, the method including cleaning an inside of a reactor of the apparatus, wherein the cleaning of the inside of the reactor of the apparatus comprises supplying a cleaning gas including halogens with being activated by using a remote plasma generator to the reactor and simultaneously supplying a carbon-removing gas without being activated to the reactor.

### Advantageous Effects

As described above, the present invention provides an in-situ cleaning method of an apparatus for depositing a carbon-containing film. When, conventionally, cleaning is performed by using only a corrosive gas, a by-product in a solid form is generated in a reactor and thus, the reactor cannot be completely cleaned. In the present invention, the reactor can be cleaned without generating a by-product in a solid form by removing a metal by-product in the reactor by using a cleaning gas including halogens and adding a carbon-removing gas to the cleaning gas including halogens.

In particular, the present invention introduces a cleaning method of a reactor by partially activating gases. The cleaning gas is used in an activated state, and the carbon-removing gas is used without being activated. In the method, reproducibility according to reactors is excellent, and a wider cleaning process margin can be obtained.

### DESCRIPTION OF DRAWINGS

FIG. 1 illustrates an apparatus for depositing a carbon-containing film used to perform a cleaning method, according to an embodiment of the present invention.

FIG. 2 is a flowchart illustrating a cleaning method according to an embodiment of the present invention.

FIG. 3 is a flowchart illustrating a cleaning method according to another embodiment of the present invention.

### BEST MODE

In the present invention, the cleaning gas may be one selected from

the group consisting of NF₃, C₂F₆, CF₄, CHF₃, and F₂ and a combination thereof. The carbon-removing gas may be a gas including oxygen (O) or hydrogen (H). The carbon-removing gas may be one selected from the group consisting of O₂, N₂O, O₃, NH₃, and H₂ and a combination thereof.

Before the supplying of the cleaning gas and the carbon-removing gas, the method may further include performing O₂ treatment so as to primarily remove carbon that exists on the surface of a by-product inside the reactor. After the cleaning of the inside of

the reactor, the method may further include treating the apparatus for depositing a carbon-containing film by using a hydrogen-containing gas so as to remove a residual of the cleaning gas. In this case, the hydrogen-containing gas may be one selected from the group consisting of H₂, NH₃, SiH₄, and H₂O and a combination thereof.

After the cleaning of the inside of the reactor, the method may further include seasoning an inside of the reactor by using the carbon-containing film.

### Mode for Invention

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

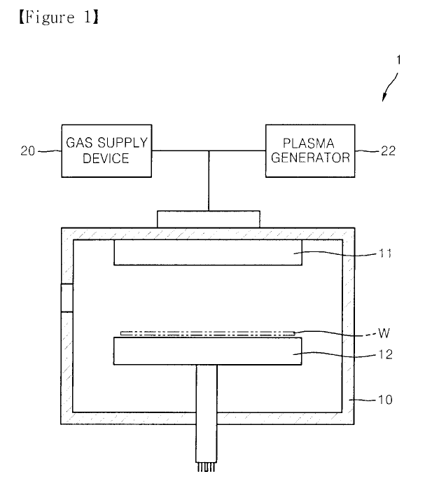

First, a cleaning method according to the present invention can be used to clean an apparatus for depositing a film illustrated in FIG. 1.

An apparatus 1 for depositing a film of FIG. 1 comprises a reactor 10 having an internal space, a wafer block 12 which is installed to be ascended or descended in the internal space of the reactor 10 and on which a wafer W is disposed, and a shower head 11 which sprays a gas so that a film can be formed on the wafer W disposed on the wafer block 12.

The apparatus 1 is used to deposit a carbon-containing film on the wafer W for a semiconductor such as a silicon wafer or a liquid crystal display (LCD) glass substrate. The apparatus 1 further comprises a gas supply device 20 which supplies a source gas and an inert gas for a process to the reactor 10 through a gas line. In the cleaning method according to the present invention, a cleaning gas includes halogens and is activated by using a remote plasma generator 22 and is supplied to the reactor 10.

The cleaning gas including halogens may be one cleaning gas selected from the group consisting of NF₃, C₂F₆, CF₄, CHF₃, and F₂ and a combination thereof. A carbon-removing gas may be a gas including oxygen or hydrogen. For example, the carbon-removing gas may be one selected from the group consisting of O₂, N₂O, O₃, NH₃, and H₂ and a combination thereof.

Next, a cleaning method of the reactor 10 of the apparatus 1 of FIG. 1 according to exemplary embodiments of the present invention will be described.

### Embodiment 1

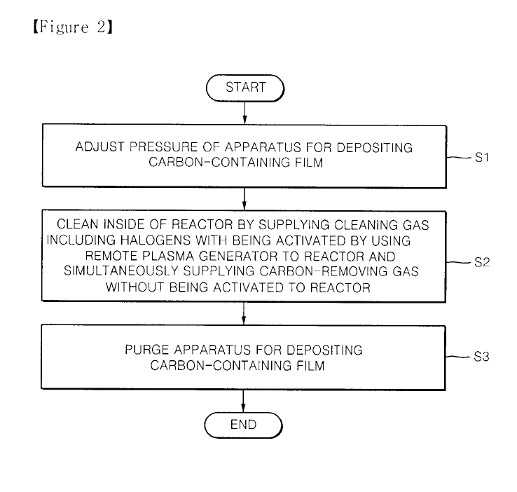

FIG. 2 is a flowchart illustrating a cleaning method according to an embodiment of the present invention.

Referring to FIGS. 1 and 2, the pressure inside the reactor 10 of the apparatus 1 is adjusted to be suitable for cleaning, in operation s1 of FIG. 2. The pressure inside the reactor 10 is 0.3-10 torr. As the pressure inside the reactor 10 decreases, a cleaning efficiency increases. The pressure inside the reactor 10 is maintained at 0.5-4 torr.

Next, in operation s2, the inside of the reactor 10 is cleaned without stopping the apparatus 1 by supplying a cleaning gas including halogens with being activated by using a remote plasma generator 22 to the reactor 10 and simultaneously supplying a carbon-removing gas without being activated to the reactor 10. Time for the cleaning operation s2 varies according to the contamination degree of the reactor 10 and may vary depending on whether 1000 or 500 wafers are treated. Although changed according to conditions, carbon-containing film is removed at approximately 1000 Å/min. Thus, when 1000 wafers having the film thickness of 200 Å are treated, cleaning is performed for 200 minutes.

When a film such as TaCN is deposited by using the apparatus 1, the cleaning gas including halogens may be NF₃, and the carbon-removing gas may be O₂. A cleaning efficiency can be further maximized by operating the remote plasma generator 22, plasmatizing the cleaning gas and supplying the cleaning gas to the reactor 10. Argon (Ar) may be used as a base process gas for generating plasma.

When cleaning is performed by using only a corrosive gas that is used as a general dry cleaning gas, carbon and fluoride that exist in a reactor, react with each other to form fluoride carbon and a by-product in a solid form is generated. Thus, the reactor 10 cannot be completely cleaned. In the present invention, the reactor 10 can be cleaned without generating a by-product in a solid form by removing a metal by-product in the reactor 10 by using a cleaning gas including halogens and adding a carbon-removing gas to the cleaning gas including halogens. Therefore, after a predetermined amount of wafers are treated, in-situ cleaning can be performed without stopping an apparatus for depositing a film so that productivity of the apparatus for depositing a film can be maximized. In particular, the present invention is implemented by partially activating gases. The cleaning gas is used in an activated state, and the carbon-removing gas is used without being activated.

When the cleaning gas and the carbon-removing gas are simultaneously activated and are supplied, first, they react with each other and an organic by-product such as Teflon is generated. According to the experimental result carried by the present inventors, each flux of the cleaning gas and the carbon-removing gas must be adjusted within a very narrow range so as not to generate the organic by-product. Thus, the present invention provides a method by which a cleaning efficiency is maximized by activating only the cleaning gas and carbon is removed without activating the carbon-removing gas while the organic by-product is not generated. In the method, each flux of the cleaning gas and the carbon-removing gas need not to be finely adjusted so that the organic by-product is not generated. Thus, reproducibility according to reactors is excellent, and a wider cleaning process margin can be obtained.

When the reaction of the cleaning operation s2 is finished, a purging operation s3 of removing a gas that remains in the reactor 10 is performed. The reactor 10, a gas line, and the remote plasma generator 22 are purged. This is because the cleaning gas etc. may remain in the reactor 10 and the gas line etc. When such a problem does not occur, the purging operation s3 may be omitted. In this regard, a purging gas may be an inert gas, for example, Ar or N₂.

### Embodiment 2

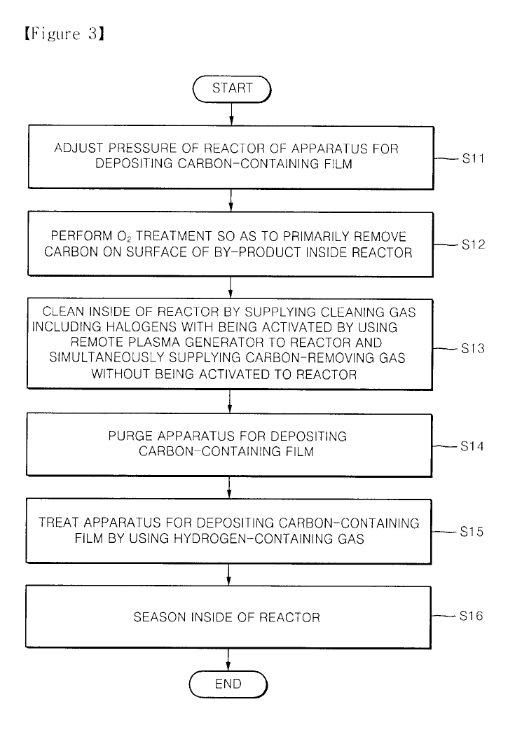

FIG. 3 is a flowchart illustrating a cleaning method according to another embodiment of the present invention.

The cleaning method according to the present embodiment of the present invention is similar to the cleaning method of FIG. 2 but is different from the cleaning method of FIG. 2 in that additional operations are included.

Referring to FIGS. 1 and 3, the pressure inside the reactor 10 is adjusted to be suitable for cleaning, in operation s11 of FIG. 3.

Next, in operation s12, O₂ treatment is performed. O₂ treatment (s12) is performed to oxidize carbon on the surface of the by-product inside the reactor 10 and to primarily remove carbon.

Subsequently, in operation s13, the inside of the reactor 10 is cleaned by supplying a cleaning gas including halogens with being activated by using the remote plasma generator 22 to the reactor 10 and simultaneously supplying a carbon-removing gas without being activated to the reactor 10.

When the cleaning operation s13 is finished, an operation s14 of removing a gas that remains in the reactor 10 is performed. Operation s3 of FIG. 2 may be quoted for operation s14.

Next, more additionally, in operation s15, an operation of treating the apparatus 1 by using a hydrogen-containing gas may be further performed so as to remove the residual of the cleaning gas. In this case, the hydrogen-containing gas may be one selected from the group consisting of H₂, NH₃, SiH₄, and H₂O and a combination thereof. The hydrogen-containing gas may be simply purged or may be treated by generating plasma in the hydrogen-containing gas.

Next, an operation s16 of seasoning the inside of the reactor 10 by using the carbon-containing film is performed, and the reactor 10 is optimized for film deposition.

In order to deposit the film by loading a wafer after cleaning is finished, atmosphere in the reactor 10 need to be constituted. This is because a problem in which a firstly-deposited film after cleaning is completed and a film that is deposited by using next process do not have the same property (such as a reduction in the thickness of the film) occurs. Thus, as the last operation of the cleaning method, the seasoning operation s16 of coating the film to be deposited on the wafer on a surface inside the reactor 10 in advance before a first wafer is loaded, may be performed.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, an apparatus for depositing a carbon-containing film can be effectively cleaned. A metal by-product inside a reactor is cleaned by supplying a cleaning gas including halogens with being activated by using a remote plasma generator to the reactor and simultaneously by supplying a carbon-removing gas without being activated to the reactor such that the reactor can be cleaned without generating a by-product in a solid form. Therefore, after a predetermined amount of wafers are treated, in-situ cleaning can be performed without stopping the apparatus for depositing a carbon-containing film such that productivity of the apparatus for depositing a carbon-containing film can be maximized.

In particular, as a cleaning method of the reactor by partially activating gases, the cleaning gas is used in an activated state, and the carbon-removing gas is used without being activated. In the method, reproducibility according to reactors is excellent, and a wider cleaning process margin can be obtained.

1. A dry cleaning method of an apparatus for depositing a carbon-containing film, the method comprising cleaning an inside of a reactor of the apparatus, wherein the cleaning of the inside of the reactor of the apparatus comprises supplying a cleaning gas including halogens with being activated by using a remote plasma generator to the reactor and simultaneously supplying a carbon-removing gas without being activated to the reactor.

2. The method of claim 1, wherein the cleaning gas is one selected from the group consisting of NF₃, C₂F₆, CF₄, CHF₃, and F₂ and a combination thereof.

3. The method of claim 1, wherein the carbon-removing gas is a gas including oxygen (O) or hydrogen (H).

4. The method of claim 1, wherein the carbon-removing gas is one selected from the group consisting of O₂, N₂O, O₃, NH₃, and H₂ and a combination thereof.

5. The method of claim 1, further comprising, before the supplying of the cleaning gas and the carbon-removing gas, performing O₂ treatment so as to primarily remove carbon that exists on the surface of a by-product inside the reactor.

6. The method of claim 1, further comprising, after the cleaning of the inside of the reactor, treating the apparatus for depositing a carbon-containing film by using a hydrogen-containing gas so as to remove a residual of the cleaning gas.

7. The method of claim 6, wherein the hydrogen-containing gas is one selected from the group consisting of H₂, NH₃, SiH₄, and H₂O and a combination thereof.

8. The method of claim 1, further comprising, after the cleaning of the inside of the reactor, seasoning an inside of the reactor by using the carbon-containing film.
